(19) United States
(12) Patent Application Publication
(10) Pub. No.: US 2016/0223256 A1
(43) Pub. Date: Aug. 4, 2016

(54) Plant Matter Dryer

(71) Applicant: Harvey Romanek, Seminole, FL (US)

(72) Inventor: Harvey Romanek, Seminole, FL (US)

(21) Appl. No.: 14/873,242

(22) Filed: Oct. 2, 2015

Related U.S. Application Data
(63) Continuation of application No. 14/611,579, filed on Feb. 2, 2015.
Application No. 14/611,579 is a continuation of application No. 14/609,050, filed on Jan. 29, 2015.

(51) Int. Cl. F26B 3/28

(52) U.S. Cl. CPC F26B 3/28

(57) ABSTRACT

A plant matter drying system includes an enclosure with a door and an internally mounted ultraviolet lamp for disinfecting plant matter. A heating element creates an internal temperature that is higher than ambient temperature and an optional fan circulates air within the enclosure and over the plant matter, thereby drying and/or decarboxylating (depending upon the internal temperature and time periods) the plant matter that is positioned within the system. During decarboxylation, the ultraviolet lamp is operated for less time than is the optional fan and heating element. In some embodiments, vents exchange air within the enclosure with air external to the enclosure.

### CROSS-REFERENCE TO RELATED APPLICATION

This application is a continuation of to U.S. patent application Ser. No. 14/611,579, filed Feb. 2, 2015, which in turn is a continuation of to U.S. patent application Ser. No. 14/609,050, filed Jan. 29, 2015.

### FIELD OF THE INVENTION

This invention relates to the drying of plant matter and more particularly to an appliance for drying and/or decarboxylation of plant matter.

### BACKGROUND

Various plants are often dried to preserve flavor and to extend the useful life of the plant. For example, certain herbs, although flavorful when freshly picked, will only last for a few days. As such plants do not grow well during the colder months, in many climates it is desired to dry these plants for storage and use during colder months. Therefore, there is a need to preserve these plants for use after the growing season concludes. Many plants such as basil, oregano, onion, sage, thyme, are preserved by drying the plant and storing the dried leaves in jars or other air-tight containers.

An example of such plant matter is herbs. Often, herbs are used in food, flavoring, medicines, aromatic compounds, etc. For some such applications, it is necessary to decarboxylate the herbs to produce substances that produce the desired effect. For example, green tea has theanine (amino acid). Through the decarboxylation of theanine, gamma amino butyric acid (GABA) is produced and it is believed that gamma amino butyric acid (GABA) is a primary neurotransmitter inhibitor when synthesized by the brain.

Likewise, in areas of the world in which cannabis is legal for medicinal use and/or use as a euphoric, this plant is often consumed, transported, and sold, in a dry form, typically consumed by smoking the dried flower buds and leaves. One way to dry cannabis plants is to hang the plants upside down in a warm dry area for many days or weeks. Since the cannabis plants contain moisture, care must be taken to vent the area to prevent mold and other growth and contamination. When selling such plant matter, the purchaser wants the product to be as dry as possible since the price paid is usually based on weight and extra moisture results in higher weighing material and the purchaser paying for the extra moisture.

When cannabis is consumed, transported, and sold as an eatable, the final product is consumed after mixing and/or cooking in/with a food product, producing cookies, brownies, cakes, etc. Cannabis as grown and harvested typically has very little THC (Tetrahydrocannabinol). The THC typically provides many of the medicinal and euphoric elements of the plant. Such Cannabis has abundant THCA (Tetrahydrocannabinolic Acid) which has anti-inflammatory and neuro-protective effects, but lacks some of the desired medicinal and euphoric elements. To convert the THCA to THC, a carbon atom need be removed from the THCA. In order to release this carbon atom, the cannabis needs to be decarboxylated. This is achieved by heating cannabis to a specific temperature for sufficient time so that the THCA releases the carbon atom and the THCA converts to THC. Note that it is important to control the temperature of the decarboxylation of cannabis so as not to vaporize other important compounds such as cannabinoids, terpenes, and flavonoids. Since cannabinoids, terpenes, and flavonoids have boiling points above 245 degrees (F.), it is important to decarboxylate at a temperature below 245 degrees (F.), e.g., at 240 degrees (F.).

In the past, creating a dry environment to effectively dry plant matter required special rooms with dehumidification and, sometimes, heat. This is often difficult in warm, humid climates and warmth plus moisture often promotes growth of mold and fungus.

It is desired that the plant matter be free of germs, bacteria, and mold/spores, especially when consumed by eating. This is difficult to accomplish in existing drying systems. Further, when the cannabis plants are watered with reclaimed water that is not potable because of possible contamination, residual amounts of the reclaimed water reside on the cannabis leaves and seed pods, further contributing to health concerns.

What is needed is a drying device that will effectively dry and/or decarboxylate plant matter while reducing or eliminating mold, bacteria and other pathogens.

### SUMMARY OF THE INVENTION

An electronic device for drying and/or decarboxylation of plant matter includes an enclosure with an internal ultraviolet lamp for disinfecting the plant matter. A heating element creates an internal temperature to reduce humidity and/or to decarboxylate the plant matter. An optional fan circulates air within the device and/or exchanges air with outside air, thereby drying the plant matter. Precautions are included to reduce emission of ultraviolet light to outside of the enclosure.

In one embodiment, a plant matter drying system has an enclosure, with a base portion and a door portion. The door portion is hingedly connected to the base portion and has an open position for access to an inside area of the enclosure and a closed position preventing access to the inside area of the enclosure. A shelf within the base portion supports a portion of plant matter. A heating element within the base portion provides heat to the portion of plant matter when supplied with an electrical current. A optional forced air flow system circulates air within the plant matter drying system, the air flowing over the portion of plant matter and the air flowing around the heating element. When present, the forced air flow system includes a fan that operates when supplied with electrical current. An ultraviolet lamp within the enclosure emits ultraviolet light when supplied with electrical current; the ultraviolet light is directed towards the portion of plant matter. A first timer electrically connected to the heating element and, when present, to the fan. The first timer is configured to provide electrical current to operate the heating element and fan, when present, for a first time period. A second timer is electrically connected the ultraviolet lamp and is configured to provide electrical current to operate the ultraviolet lamp for a second time period.

In another embodiment, a plant matter drying system has an enclosure with a base portion and a door portion. The door portion is connected to the base portion by, for example, hinges, providing an open position for access to an inside area of the enclosure and a closed position preventing access to the inside area of the enclosure. A first shelf within the base portion supports a portion of plant matter and a second shelf within the base portion has a grill for enabling air through there through. The second shelf forms a gap between the first shelf and the second shelf and also forms a cavity between the second shelf and a floor of the base portion. An ultraviolet lamp is mounted within the enclosure for emitting ultraviolet light directed towards the portion of plant matter. An interlock system disables flow of an electrical current to the ultraviolet lamp when the door portion is not in the closed position. A heating element is within the base portion, providing heat to the portion of plant matter and an optional fan circulates air within the plant matter drying system. When present, the fan pulls air from the grill and sends the air through the heating element and back onto the plant matter. A device provides electrical current to operate the optional fan and the heating element for a first time period and provides the electrical current to operate the ultraviolet lamp for a second time period.

In another embodiment, a plant matter drying system has an enclosure with a base portion and a door portion. The door portion is interfaced to the base portion and has an open position for access to an inside area of the enclosure and a closed position preventing access to the inside area of the enclosure. A first shelf and a second shelf are within the base portion. The second shelf has a grill for enabling air through there through and the second shelf forms a gap between the first shelf and the second shelf. The second shelf forms a cavity between the second shelf and a floor of the base portion. An ultraviolet lamp is mounted within the enclosure for emitting ultraviolet light. An interlock is provided for disabling the ultraviolet lamp when the door portion is not in the closed position. A heating element is disposed within the enclosure and, in some embodiments, a fan is positioned below the grill, drawing air from the grill and circulating air within the plant matter drying system. A device provides for operating the fan, when present, and the heating element for a first time period and for operating the ultraviolet lamp for a second time period.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of an exemplary plant matter drying system.

FIG. 2 illustrates a second perspective view of the exemplary plant matter drying system.

FIG. 3 illustrates a cut-away view of the exemplary plant matter drying system.

FIG. 4 illustrates a schematic view of the exemplary plant matter drying system.

FIG. 5 illustrates a second schematic view of the exemplary plant matter drying system.

FIG. 6 illustrates a third schematic view of the exemplary plant matter drying system.

FIG. 7 illustrates a schematic view of a controller of the exemplary plant matter drying system.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

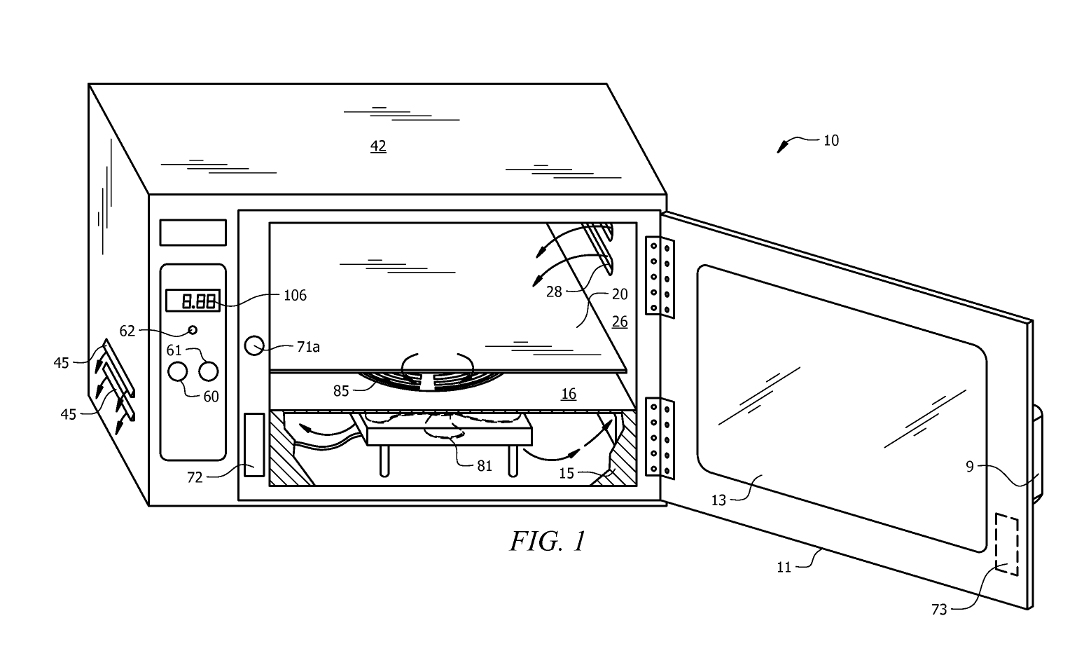

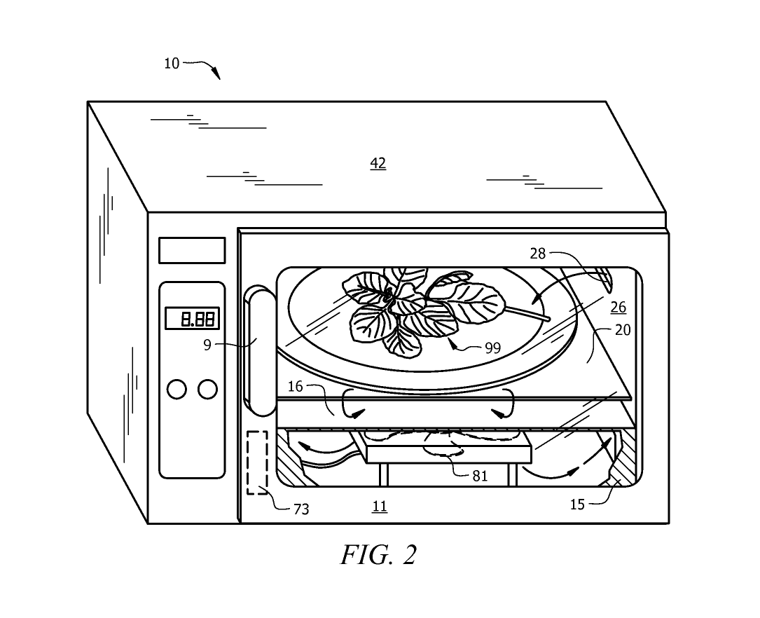

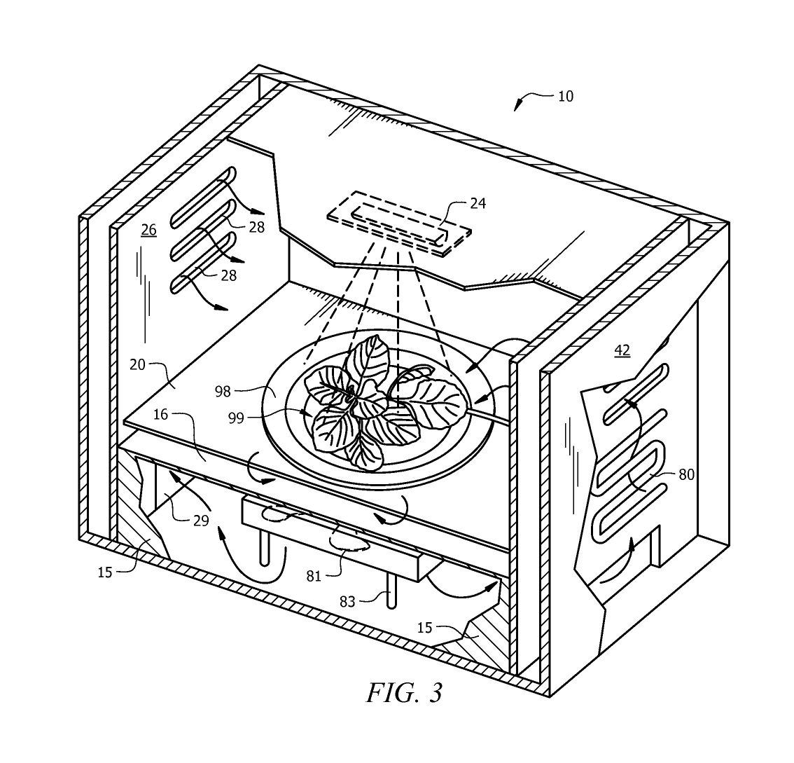

Referring to FIGS. 1, 2, and 3, perspective views of an exemplary plant drying system 10 with the door portion 11 shown in an open position (FIG. 1) and the door portion 11 shown in a closed position (FIG. 2). The plant drying system 10 dries, decarboxylates, and/or disinfects plant matter 99 using heat, a germicidal ultraviolet light, and/or air flow. The plant drying system 10 has at least two modes of operation. A first mode of operation (decarboxylates mode) decarboxylates the plant matter 99 by providing heat of preferably between 240 and 245 degrees Fahrenheit (F) to the plant matter 99 for a shorter duration of preferably between 50 and 70 minutes, for example 60 minutes. A second mode of operation dries the plant matter 99 by providing a lower heat for a longer duration. This lower heat is typically between 100 and 145 degrees Fahrenheit (F) and the duration is typically between 30 minutes and twenty hours, preferably between 113 and 118 degrees Fahrenheit (F) and between twelve hours and sixteen hours, and more preferably 114 degrees Fahrenheit (F) for 13 hours.

In the first mode (decarboxylation mode), decarboxylation occurs due to the higher temperatures through a chemical reaction that removes a carboxyl group and releases carbon dioxide CO₂. For example, in certain plant matter 99, Tetrahydrocannabinolic acid (THCA) decarboxylates, yielding the psychoactive compound Tetrahydrocannabinol (THC). In this mode, the ultraviolet lamp 24 is operated (emits ultraviolet light) for a period of time typically less than the full decarboxylation time cycle to limit blocking of the release of chlorophyll. For example, the ultraviolet lamp 24 operates for several minutes, between seven and nine minutes, and preferably eight minutes, at any time during the first mode, preferably at the beginning of the decarboxylation cycle. The ultraviolet light emitted from the ultraviolet lamp 24 is directed at the plant matter 99, thereby sanitizing the plant matter 99, killing many, most, or all pathogens present in the plant matter 99.

In the second mode (drying mode), drying occurs due to the lower temperatures for a longer period of time. In this mode, the ultraviolet lamp 24 is operated (emits ultraviolet light) for a preprogrammed amount of time, up to the amount of time duration of the drying cycle (e.g., up to twenty hours) but preferably less than the full drying period, for example, eight minutes. It is preferred to operate the ultraviolet lamp 24 for several minutes (e.g., 15-30 minutes, preferably eight minutes) at any time during the second mode. The ultraviolet light emitted from the ultraviolet lamp 24 is directed at the plant matter 99, thereby sanitizing the plant matter 99, killing many, most, or all pathogens present in the plant matter 99.

The plant drying system 10 has an enclosure that includes a base portion 43 and a door portion 11 that is attached to the base portion 43 such that the door portion is configured to open (open position) for placement and removal of the plant matter 99 into/from the plant drying system 10. The ultraviolet lamp 24 (e.g., any germicidal ultraviolet lamps as known in the industry) is mounted inside the base portion 43, preferably directed at an area where the plant matter 99 will be placed during operation of the plant drying system 10. The ultraviolet lamp emits ultraviolet light in one or more wavelengths of radiation for the destruction of pathogens, germs, mold, spores, etc. Ultraviolet light (400 nm to 100 nm) is categorized into three basic ranges: UVA from 400 nm to 320 nm, UVB from 230 nm to 280 nm, and UVC from 280 nm to 100 nm. Although there is no limitation of the wavelengths of ultraviolet light emitted by the ultraviolet lamp(s) 24, typically UVC light in the range of 280 nm to 100 nm is preferred, because UVC has been shown to be effective in destroying pathogens, as well as UVB in the range of 230 nm to 280 nm, with 254 nm having the highest efficacy in destroying certain pathogens.

The plant matter 99 is placed upon a shelf 20, preferably in a container 98 that enables easy removal of the plant matter 99 after drying and/or decarboxylating. The ultraviolet lamp 24 emits ultraviolet light onto the plant matter 99 as the plant matter 99 sits on a shelf 20, thereby disinfecting the plant matter 99. In some embodiments, the shelf 20, inner walls 26 of the base portion 43 and/or ceiling of the base portion 43 have mirrored surfaces (e.g. chromed) facing toward the location where the plant matter 99 is placed during drying/decarboxylating. When present, the mirrored surfaces intensify the ultraviolet light from the ultraviolet lamp 24 and provide ultraviolet light at many different angles to reach within layers of the plant matter 99.

In the exemplary plant drying system 10, a sub-floor 16 is positioned beneath the shelf 20. When the door 11 is closed, there is a gap between a forward edge of the shelf 20 and the door 11. As will be discussed, this gap provides for air flow from an area above the shelf 20 to an area between the shelf and the sub-floor 16. The sub-floor 16 is occluded by a front wall 15, while a grill 85 with optional filter media enables flow of air from between the shelf 20 and sub-floor 16 to a space between the sub-floor 16 and the floor of the base portion 43. When present, the fan 81, in this example, is mounted to the sub-floor 16 and/or to the floor of the base portion 43 by, for example, stand-offs 83, and the fan 81 operates to draw air in from between the sub-floor 16 and the shelf 20, pushing the air through orifices 29 into a gap between inner walls 26 and the walls of the base portion 43. In some embodiment, a filter media covers the orifices 29, for example, a Hepa filter media. The air within the gap between inner walls 26 and the walls of the base portion 43 is heated by one or more heating elements 80 before being directed back towards the plant matter 99 through vents 28 in the inner walls 26.

The door portion 11 preferably has a mechanism for opening the door portion 11, such as a handle 9, though in some embodiments, the door portion 11 is opened by any way known in the industry. In some embodiments, the door portion 11 includes a window 13 (as shown), permitting sight of the plant matter 99 while the plant matter 99 is within the plant drying system 10. It is known that certain ultraviolet light is harmful to the eyes and, therefore, the window 13, when present, blocks the harmful ultraviolet light. In some embodiments, the inside surface of the door portion 11 is coated or metalized (e.g., chromed) to better reflect the ultraviolet light from the ultraviolet lamp 24 onto the plant matter 99.

Since certain ultraviolet light is harmful to the eyes, an interlock system is provided to assure that the ultraviolet lamp 24 is not operational while the door portion 11 is open. Although many interlock systems are known, the exemplary plant drying system 10 has a magnet 73 and magnetic switch 72 such that, when the door portion 11 is closed, the magnet 73 is in the vicinity of the magnetic switch 72, thereby changing the conductance of the magnetic switch 72 (e.g., closing the magnetic switch 72) to signal the plant drying system 10, enabling operation of the ultraviolet lamp 24. When the door portion 11 is opened, the magnet 73 leaves the vicinity of the magnetic switch 72, thereby changing the conductance of the magnetic switch 72 (e.g., opening the magnetic switch 72) to signal the plant drying system 10, disabling operation of the ultraviolet lamp 24.

Although the examples show one particular plant drying system 10, other configurations of plant drying systems 10 having different placement of components and different air-flow channels and directions are fully anticipated, having similar drying and decarboxylating modes of operation.

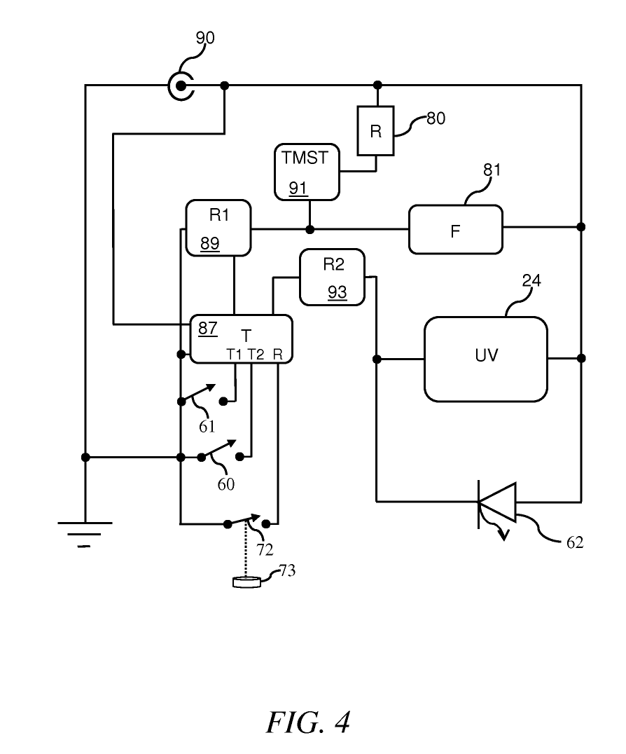

In some embodiments, switches 60/61, an indicator 62, and/or a display 106 are provided on an outside surface of the base portion 43 such as the front surface of the base portion 43. Operation of the switches 60/61, the indicator 62, and/or the display 106 is described with FIGS. 4-7.

Referring now to FIGS. 4-6, schematic views of the exemplary plant matter drying system are shown. Power is provided to the plant drying system 10 in any way known in the industry, for example, as shown, through a power jack 90, one side to ground and the other is connected to the heating element(s) 80, the optional fan 81, the ultraviolet lamp 24, the indicator 62 (an LED in this example), and other circuitry (e.g. timers 87) as needed.

Although many user interfaces with the same or different configurations and operation of switches 61/60, keypads 108, displays 106, and/or indicators 62 are anticipated.

The exemplary user interface shown in FIG. 4 has a first mode switch 61 (decarboxylation cycle) and a second mode switch 60 (drying cycle). When the first mode switch 61 (decarboxylation cycle) is pressed (making contact in this example), the timer 87 starts a decarboxylation cycle sequence. During the decarboxylation cycle sequence, the timer 87 energizes a first relay 89 providing electrical current to the thermostat 91 and the fan 81 and the timer 87 energizes a second relay 93, providing electrical current to the ultraviolet lamp 24 and the indicator 62. The thermostat 91 is positioned within the base portion 43, within the air flow. The thermostat 91 monitors air temperature within the base portion 43 and provides electrical current to the heating element(s) 80 when the air temperature is below a preset temperature, e.g., when the air temperature is between 240-245 degrees F. during decarboxylation. In this example, the timer 87 operates the optional fan 81 and heating element(s) 80/thermostat 91 during the entire cycle (e.g. 50 to 70 minutes), optionally circulating air and moving heated air over the plant matter 99. The ultraviolet lamp 24 and indicator 62 (optional) are controlled by the timer 87 through a second relay 93 and operate for, in some embodiments, a different amount of time during the decarboxylate cycle, as discussed prior, typically from seven to nine minutes. When the lesser amount of time interval expires (e.g. seven to nine minutes), the timer 87 de-energizes the second relay 93, preventing flow of electrical current through the ultraviolet lamp 24 and the indicator 62. When the decarboxylate cycle time interval expires (e.g. 50 to 70 minutes), the timer 87 de-energizes the first relay 89, preventing flow of electrical current through the heating element(s) 80, and the optional fan 81 thereby ending the decarboxylate cycle.

When the second mode switch 60 (drying cycle) is pressed (making contact in this example), the timer 87 starts a drying cycle sequence. During the drying cycle sequence, the timer 87 energizes a first relay 89 providing electrical current to the thermostat 91 and, when present, the fan 81; and the timer 87 energizes a second relay 93, providing electrical current to the ultraviolet lamp 24 and the optional indicator 62. The thermostat 91 is preferably positioned within the enclosure 42. The thermostat 91 monitors air temperature within the enclosure 42 and provides electrical current to the heating element(s) 80 when the air temperature is below a preset temperature, during drying, for example, when the air temperature is below 103 to 118 degrees F. In this example, the timer 87 operates the heating element(s) 80/thermostat 91 and the fan 81 when present during the entire cycle (e.g. seven to nine hours), providing heated air around the plant matter 99. The ultraviolet lamp 24 and indicator 62 (optional) are controlled by the timer 87 through a second relay 93 and operate for a predetermined amount of time during the drying cycle, as discussed prior, for example, any amount of time from seven minutes up to the entire drying cycle time (e.g. 13 hour drying cycle). When the predetermined amount of time interval expires (e.g. after seven minutes), the timer 87 de-energizes the second relay 93, preventing flow of electrical current through the ultraviolet lamp 24 and the optional indicator 62. When the drying cycle time interval expires (e.g. thirteen hours), the timer 87 de-energizes the first relay 89, preventing flow of electrical current through the heating element(s) 80, and the fan 81 thereby ending the drying cycle.

If at any instance, the door portion 11 is opened while the second relay 93 is providing electrical current to the ultraviolet lamp 24, the magnetic switch 72 signals the circuit (e.g., through the timer 87) and the second relay 93 to de-energize the (stop flow of electrical current) through the ultraviolet lamp 24, thereby ceasing any emission of ultraviolet light until the door portion 11 is closed, as a safety measure. In some embodiments, the magnetic switch 72 (e.g. reed relay) is electrically interfaced in series with the ultraviolet lamp 24 to assure no electrical current flows through the ultraviolet lamp 24 while the door portion 11 is open.

There are many timers known in the industry including electro-mechanical timers (bi-metallic, etc.), clock-movement timers, and semiconductor timers, along with many circuit configurations to achieve the same operational results; all are anticipated here within. Exemplary timers are exemplified by the industry standard 555/556 timer. In some cases, the power output of such a timer is sufficient to operate the heating element(s) 80, the optional fan 81, and/or the ultraviolet lamp 24 without the use of the relays 89/83. In some exemplary systems, the relays 89/93 are semiconductor relays, power transistors, or power FETs, as known in the industry. In some embodiments, the timer 87 is implemented by a processor as it is known to implement discrete logic with processing elements and software and visa versa.

Since, during the drying cycle, the air in the plant drying system 10 is heated by the heating element 80 to a temperature above ambient, for example, 113 F to 118 F, as air is circulated, moisture is removed from the plant matter 99. In some embodiments, the moist air is exhausted from the plant drying system 10 through the vents 45. Preferably, the vents 45 are positioned such that minimal ultraviolet light from the ultraviolet lamp 24 exit through the vents 45.

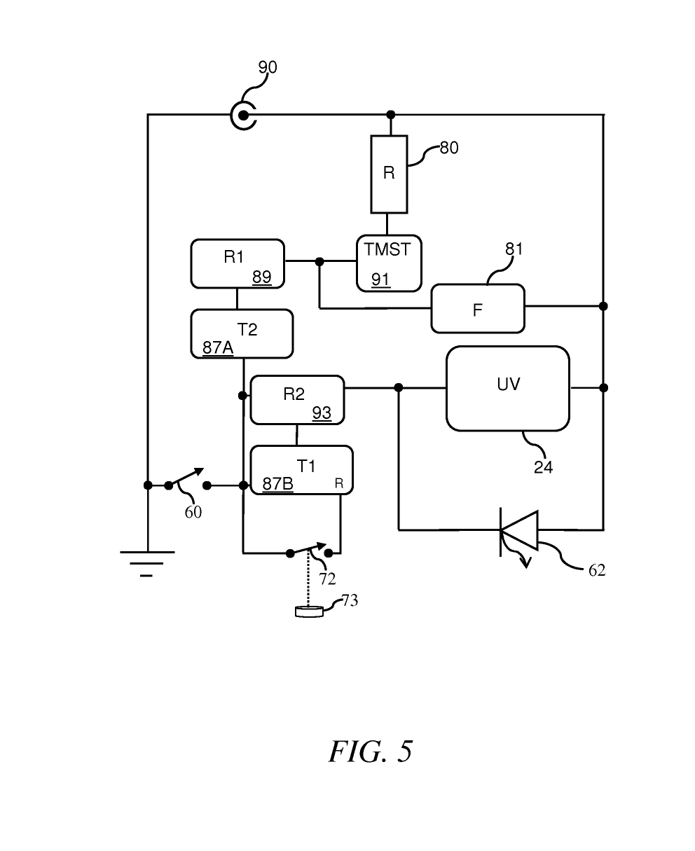

The plant drying system 10 shown in FIG. 5 has a single operation switch 60 and this embodiment of the plant drying system 10 is configured to operate in a single mode, either a fixed decarboxylation cycle or a fixed drying cycle. In this embodiment, separate timers 87A/87B operate each subset of the timing intervals. In embodiments in which the plant drying system 10 is configured for decarboxylation, when the single operation switch 60 (decarboxylation cycle) is operated (making contact in this example), both timers 87A/87B starts the decarboxylation cycle sequence. During the decarboxylation cycle sequence, the first timer 87A energizes a first relay 89 providing electrical current to the thermostat 91 and to the optional fan 81 and the second timer 87B energizes a second relay 93, providing electrical current to the ultraviolet lamp 24 and the indicator 62. The thermostat 91 is positioned within the enclosure 42. The thermostat 91 monitors air temperature within the enclosure 42 and provides electrical current to the heating element(s) 80 when the air temperature is below a preset temperature, for example, when the air temperature is below 240-245 degrees F. Once the temperature within the enclosure 42 reaches the decarboxylation temperature (e.g. between 240 F and 245 F), the thermostat 91 stops flow of electrical current through the heating element(s) 80. In this example, the first timer 87A operates the heating element(s) 80/thermostat 91 and, when present, the fan 81 during the entire cycle (e.g. 50 to 70 minutes), providing heated air over the plant matter 99. The ultraviolet lamp 24 and indicator 62 (optional) are controlled by the second timer 87B through a second relay 93 and operate, preferably, for a lesser amount of time during the decarboxylate cycle, as discussed prior, typically from seven to nine minutes. When the lesser amount of time interval expires (e.g. eight minutes), the second timer 87B de-energizes the second relay 93, preventing flow of electrical current through the ultraviolet lamp 24 and the indicator 62. When the decarboxylate cycle time interval expires (e.g. 50 to 70 minutes), the first timer 87A de-energizes the first relay 89, preventing flow of electrical current through the heating element(s) 80, and the fan 81 thereby ending the decarboxylate cycle.

In plant drying systems configured for drying, operation of the single operation switch 60 (making contact in this example) initiates a drying cycle. During the drying cycle sequence, the first timer 87A energizes a first relay 89 providing electrical current to the thermostat 91 and the optional fan 81; and the second timer 87B energizes a second relay 93, providing electrical current to the ultraviolet lamp 24 and the indicator 62. The thermostat 91 is positioned within the enclosure 42. The thermostat 91 monitors air temperature within the enclosure 42 and provides electrical current to the heating element(s) 80 when the air temperature is below a preset temperature, during drying, for example, when the air temperature is below 114 degrees F. In this example, the timer 87 operates the heating element(s) 80/thermostat 91 and the fan 81 when present during the entire cycle (e.g. thirteen hours), providing heated air to the plant matter 99. The ultraviolet lamp 24 and indicator 62 (optional) are controlled by the second timer 87B through a second relay 93 and operate for a predetermined amount of time during the drying cycle, as discussed prior, for example, for eight minutes, though in some embodiments, up to the entire drying cycle time (e.g. thirteen hours). When the predetermined amount of time interval expires (e.g. eight minutes), the second timer 87B de-energizes the second relay 93, preventing flow of electrical current through the ultraviolet lamp 24 and the indicator 62. When the drying cycle time interval expires (e.g. thirteen hours), the first timer 87A de-energizes the first relay 89, preventing flow of electrical current through the heating element(s) 80, and the fan 81 thereby ending the drying cycle.

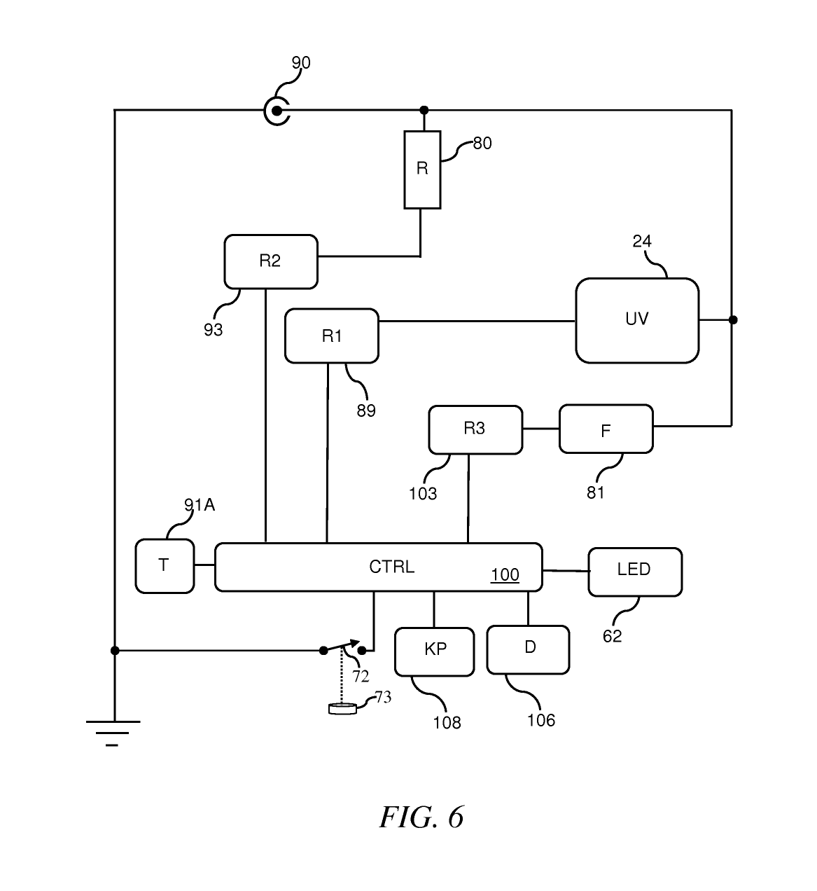

The plant drying system 10 shown in FIG. 6 has a controller 100 (e.g., a processor, microcontroller) that implements the user interface and timing functions. In this, the controller 100 includes software that initiates the decarboxylating cycles or the drying cycles based upon inputs from, for example, a keypad 108 or any other known user interface (e.g., touch screens, mice, and/or switches). In this embodiment, additional user interface options are available when more robust user interface displays 106 and keypads 108 are included. For example, with the prior discussed single or two switches 60/61 operation, the timing intervals were predetermined, for example, one hour for decarboxylating with the ultraviolet lamp operating for eight minutes. It is anticipated that, for different types of plant matter 99, different intervals are desired. In such, through a user interface using, for example, a display 106 and a keypad 108, or the like, a user interface is presented in which the user has facilities to enter the type of plant matter 99, or facilities to change timing and/or temperature values (e.g., decarboxylating for 75 minutes at 230 degrees F.).

In the example plant drying system 10 shown in FIG. 6, the controller 100 is interfaced to three relays 89/93/103, a first relay 89 controlling electrical current flow through the ultraviolet lamp 24, a second relay 93 controlling electrical current flow through the heating element(s) 80, and a third relay 103 controlling electrical current flow through the fan 81. Being that the controller 100 is more robust than simple timers 87/87A/87B, it is anticipated that the controller 100 not only switch electrical current to the heating element(s) 80, the ultraviolet lamp(s) 24 and the optional fan 81, but that the controller 100 vary the amount of electrical current flow to these devices, for example, through power transistors, FETs, etc. in place of one or more of the relays 89/93/103. In this way, additional features are provided through the user interface elements (keypad 108 and display 106) for customization for the air flow, heating speed, and ultraviolet emissions (depending upon the capabilities of the heating element(s) 80, ultraviolet lamps 24, and optional fan(s) 81).

In the example plant drying system 10 shown in FIG. 6, the magnetic switch 72 (interlock) is interfaced to the controller 100. Upon opening of the door portion 11, the magnetic switch 72 signals the controller 100, which controls the first relay 89 to stop flow of electrical current through the ultraviolet lamp(s) 24. In an alternate embodiment, the magnetic switch 72 is in series with the ultraviolet lamps 24 and, when the door portion 11 is open, the loss of magnetic field opens the magnetic switch 72, thereby preventing flow of electrical current through the ultraviolet lamp(s) 24.

In the example plant drying system 10 shown in FIG. 6, a temperature sensing device 91A (e.g., thermistor, thermal diode, thermostat) is interfaced to the controller 100. The temperature sensing device 91A is mounted in the air flow to monitor the temperature of the air around the plant matter 99, and provides a signal to the controller 100 that is proportional to the temperature of the air around the plant matter 99. The controller 100 uses this signal (representing the temperature) to control the operation of the second relay 93, and consequently, the heating element(s) 80. Once the temperature is within the desired range (e.g., between 240 F and 245 F during decarboxylating or between 113 F and 118 F during drying), the controller reduces electrical current to the heating element(s) 80 to maintain the proper temperature range.

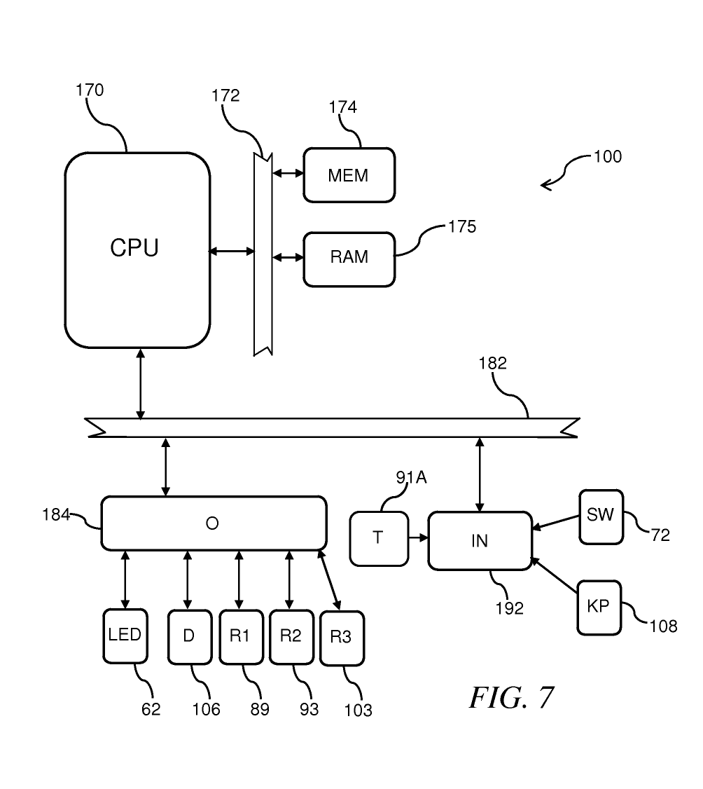

Referring to FIG. 7, a schematic view of an exemplary controller 100 as used within the plant drying system 10 is shown. The exemplary controller 100 represents a typical processor system as used with the plant drying system 10, though it is known in the industry to utilize logic in place of processors 170 and vice versa. This exemplary controller 100 is shown in its simplest form. Different architectures are known that accomplish similar results in a similar fashion and the plant drying system 10 is not limited in any way to any particular system architecture or implementation. In this exemplary controller 100, a processor 170 executes or runs programs from a random access memory 175. The programs are generally stored within a persistent memory 174 and loaded into the random access memory 175 when needed. The processor 170 is any processor, typically a microcontroller processor. The persistent memory 174, random access memory 175 interfaces through, for example, a memory bus 172. The random access memory 175 is any memory 175 suitable for connection and operation with the selected processor 170, such as SRAM, DRAM, SDRAM, RDRAM, DDR, DDR-2, etc. The persistent memory 174 is any type, configuration, capacity of memory 174 suitable for persistently storing data, for example, flash memory, read only memory, battery-backed memory, magnetic memory, etc. In some exemplary controllers 100, the persistent memory 174 is removable, in the form of a memory card of appropriate format such as SD (secure digital) cards, micro SD cards, compact flash, etc.

Also connected to the processor 170 is a system bus 182 for connecting to peripheral subsystems such as output drivers 184 and input ports 192. For example, the magnetic switch 72, a keypad 108, and the temperature sensor 91A are interfaced to input ports 192. The output drivers 184 receive commands from the processor 170 and control the indication devices 62, an optional display 106, and the relays 89/93/103 (or power driving devices).

In general, some portion of the memory 174 is used to store programs, executable code, and data such as timing intervals and temperature ranges.

The peripherals and sensors shown are examples and other devices are known in the industry such as speakers, buzzers, USB interfaces, Bluetooth transceivers, Wi-Fi transceivers, image sensors, etc., the likes of which are not shown for brevity and clarity reasons.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A plant matter drying system comprising:
an enclosure, the enclosure comprising a base portion and a door portion, the door portion connected to the base portion and the door portion having an open position for access to an inside area of the enclosure and the door portion having a closed position preventing access to the inside area of the enclosure;
an area within the base portion for supporting a portion of plant matter;
a heating element disposed within the base portion, the heating element providing heat to the portion of plant matter when the heating element is supplied with an electrical current;
an ultraviolet lamp on an inside surface of the base portion, when supplied with a second electrical current, the ultraviolet lamp emits ultraviolet light directed towards the portion of plant matter;
a first timer electrically connected to the heating element, the first timer is configured to provide the electrical current to operate the heating element for a first time period; and
a second timer electrically connected the ultraviolet lamp, the second timer is configured to provide the second electrical current to operate the ultraviolet lamp for a second time period.

2. The plant matter drying system of claim 1, wherein, in a drying mode of operation, the heating element includes a thermostat to heat the area to a temperature of between 113 F and 118 F, and the first time period is between twelve hours and sixteen hours, and the second time period is between five minutes and seven minutes.

3. The plant matter drying system of claim 1, wherein, in a drying mode of operation, the heating element includes a thermostat to heat the area to a temperature of between 109 F and 114 F, the first time period is thirteen hours and the second time period is eight minutes.

4. The plant matter drying system of claim 1, wherein, in a decarboxylation mode of operation, the heating element includes a thermostat to heat the area to a temperature of 240 F and 245 F, the first time period is between fifty minutes and seventy minutes, and the second time period is between seven minutes and nine minutes.

5. The plant matter drying system of claim 1, wherein, in a decarboxylation mode of operation, the heating element includes a thermostat to heat the area to a temperature of between 240 F and 245 F, the first time period is approximately sixty minutes and the second time period is approximately eight minutes.

6. The plant matter drying system of claim 1, further comprising an interlock switch; the interlock switch prevents flow of the second electrical current through the ultraviolet lamp responsive to the interlock switch detecting the door portion exiting the closed position.

7. The plant matter drying system of claim 6, wherein the interlock switch comprises of a magnet disposed in the door portion and a reed switch disposed in the base portion whereas the reed switch interrupts a flow of the second electrical current through the ultraviolet lamp responsive to an abatement of a magnetic field that occurs when the door portion is separated from the base portion.

8. The plant matter drying system of claim 1, further comprising a fan within the base portion, the first timer is further configured to provide the electrical current to operate the heating element to the fan for the first time period.

9. The plant matter drying system of claim 1, wherein inner surfaces of the base portion and of the door portion are mirrored to reflect the ultraviolet light.

10. The plant matter drying system of claim 1, wherein the ultraviolet light includes light having a wavelength of between 230 nm to 280 nm.

11. A plant matter drying system comprising:
an enclosure, the enclosure comprising a base portion and a door portion, the door portion hingedly connected to the base portion and the door portion having an open position for access to an inside area of the enclosure and the door portion having a closed position preventing access to the inside area of the enclosure;
an area within the base portion for supporting a portion of plant matter;
an ultraviolet lamp within the base portion, the ultraviolet lamp for emitting ultraviolet light directed towards the portion of plant matter;
means for disabling a flow of an electrical current to the ultraviolet lamp when the door portion is not in the closed position;
a heating element disposed within the base portion, the heating element providing heat to the portion of plant matter;
means for providing a second electrical current to operate the heating element for a first time period when a temperature within the enclosure is below a predetermined temperature; and
means for providing the electrical current to operate the ultraviolet lamp for a second time period.

12. The plant matter drying system of claim 11, wherein, in a drying mode of operation, the first time period is between thirty minutes and twenty hours, the second time period is between seven minutes and nine minutes, and the preset temperature is between 100 and 145 degrees Fahrenheit.

13. The plant matter drying system of claim 11, wherein, in a drying mode of operation, the first time period is thirteen hours, the second time period is eight minutes, and the preset temperature is between 113 and 118 degrees Fahrenheit.

14. The plant matter drying system of claim 11, wherein, in a decarboxylation mode of operation, the first time period is between fifty minutes and seventy minutes, the second time period is between seven minutes and nine minutes, and the preset temperature is between 240 and 245 degrees Fahrenheit.

15. The plant matter drying system of claim 11, wherein, in a decarboxylation mode of operation, the first time period is approximately sixty minutes, the second time period is approximately eight minutes, and the preset temperature is between 240 and 245 degrees Fahrenheit.

16. The plant matter drying system of claim 11, further comprising a fan, the means for providing a second electrical current for the first time period further provides electrical current to operate the fan during the first time period.

17. A plant matter drying system comprising:
an enclosure, the enclosure comprising a base portion and a door portion, the door portion interfaced to the base portion and the door portion having an open position for access to an inside area of the enclosure and the door portion having a closed position preventing access to the inside area of the enclosure;
an ultraviolet lamp within the enclosure, the ultraviolet lamp for emitting ultraviolet light;
means for disabling the ultraviolet lamp when the door portion is not in the closed position;
a heating element disposed within the base portion;
means for operating the heating element for a first time period;
means for controlling the heating element to achieve a predetermined temperature within the enclosure; and
means for operating the ultraviolet lamp for a second time period.

18. The plant matter drying system of claim 17, wherein, in a drying mode of operation, the predetermined temperature is between 113 F and 118 F, the first time period is between twelve hours and sixteen hours and the second time period is between seven minutes and nine minutes.

19. The plant matter drying system of claim 17, wherein, in a decarboxylation mode of operation, the predetermined temperature is between 240 F and 245 F, the first time period is between fifty minutes and seventy minutes, and the second time period is between seven minutes and nine minutes.

20. The plant matter drying system of claim 17, wherein the ultraviolet light includes light having a wavelength of between 230 nm to 280 nm.
